(19) United States
(12) Patent Application Publication
(10) Pub. No.: US 2010/0116952 A1
(43) Pub. Date: May 13, 2010

(54) SUPPORT FOR MULTIMEDIA UNITS

(75) Inventor: Kaj Nielsen, Thyholm (DK)

Correspondence Address: SHERIDAN ROSS PC, 1560 BROADWAY, SUITE 1200, DENVER, CO, 80202, US

(73) Assignee: BANG & OLUFSEN A/S, Struer (DK)

(21) Appl. No.: 12/525,383

(22) PCT Filed: Feb. 1, 2008
(86) PCT No.: PCT/DK08/00047

§ 371 Date: Sep. 23, 2009

(30) Foreign Application Priority Data
Feb. 2, 2007 (DK) PA 2007 00184

(51) Int. Cl. F16M 11/10; F16M 11/04

(52) U.S. Cl. 248/157

(57) ABSTRACT

The invention relates to a mechanical unit which by great flexibility enables the arranging and positioning of an electronic unit containing a screen, e.g. a TV, in such a way that the display surface of the unit can be disposed optimally with respect to the comfort of the user. By the indicated invention is achieved a large degree of freedom with regard to rotating and tilting the unit to relevant positions.

### TECHNICAL FIELD

The invention relates to a mechanical support which enables disposition of an electronic apparatus with great flexibility, in the following called “unit”. The unit may e.g. contain a screen, e.g. a TV, or other items in cases, where it is desirable to be able to manipulate the unit into a certain position in relation to a user.

### INTRODUCTION

Traditionally, supports for consumer electronics are designed as tables, roller tables and fittings for suspending the unit. These prior art means provide limited options for positioning the unit with regard to the user's comfort.

At the same time, the tendency of the units, e.g. screens for presenting interactive media, is to become still larger and heavier. This puts great demands on tables and suspension mechanisms to aid the user so that the weight of the unit does not become a problem when the position of a given unit is to be adjusted in order that the user can achieve a better functional application.

The invention describes a support that may be put on the floor, or alternatively on other horizontal surfaces, e.g. also on a common table. With the unit mounted in the support, there is enabled a simple way of manipulating the unit so that it can be brought into the desired position.

### LIST OF FIGURES

FIG. 1 shows the support in perspective view with the unit fitted;

FIG. 2 shows the support and the unit as seen from behind;

FIG. 3 shows the support and the unit as seen from the side;

FIG. 4 shows the support and the unit as seen from above;

FIG. 5 shows a perspective view of the circular underframe;

FIG. 6 shows the circular underframe in a side view;

FIG. 7 shows the circular underframe as seen from above;

FIG. 8 shows a cross-section through the underframe;

FIGS. 9-16 shows details concerning the brace;

FIG. 17 shows an alternative embodiment.

### THE INVENTION

The invention relates to a mechanical unit which enables disposition of an electronic apparatus containing a screen, e.g. a TV, with great flexibility .

The invention may be termed a support or a stand, and may be used as table, stand or support for electronic units which are equipped with a screen and possibly a loudspeaker. Examples of electronic units may be TV apparatuses, audio-video equipment, PCs and laptops, playstations and similar.

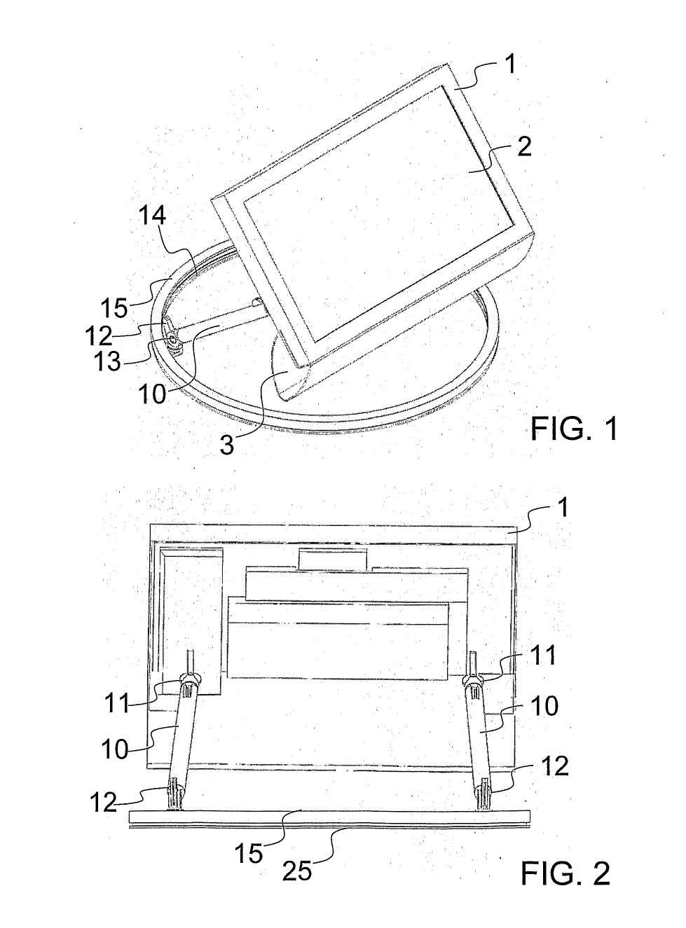

By the invention is achieved a very flexible physical positioning and setting of a given electronic apparatus (1) which is mounted in the invention (see FIG. 1). The apparatus (1) can be rotated and tilted so that maximum operational comfort is achieved for the user.

The invention may be placed on a table, on the floor or on an arbitrary horizontal surface present in the user's surroundings.

The invention consists of two main components: a) a largely circular underframe having a rotating element, and b) mounting arms (braces) fastened to the base frame and by which a given apparatus/unit can be suspended.

In one implementation of the invention, a single brace (10) can be used.

In an alternative implementation of the invention, two or more braces can be used. In the following, an example as shown in the Figures with two braces will be described.

The characteristic feature of the invention is particularly the function that a unit (1) disposed in the support will always be in neutral, stable, balanced condition. This means that a user may manipulate the unit (1) into the desired position, after which the unit remains in this position. By the user this is experienced as if the object was weightless.

The weightless sensation when changing the position of the unit is achieved by a spring (30, see FIG. 15) fitted in the stand pipe (10) (brace) and by a construction (31,32,45) connected with the spring (30) so that the spring may be acted on in dependence of the position of the unit. Springs are defined by a K-value expressed in Newton per millimetre. The force (reaction) of the spring increases the more the spring is compressed.

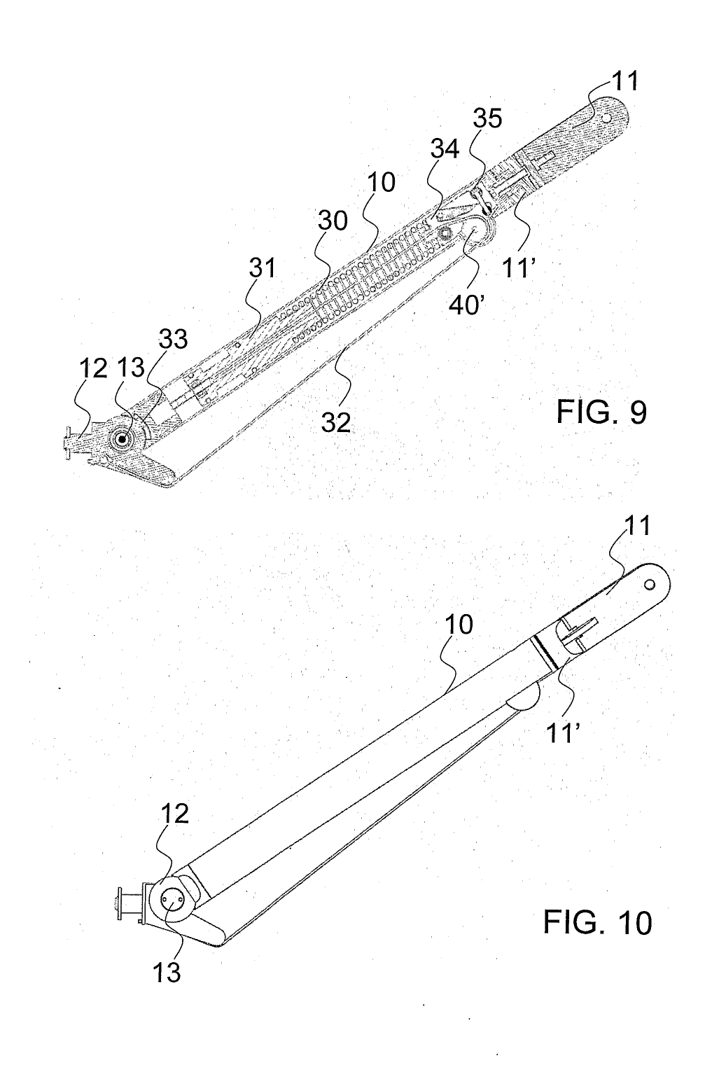

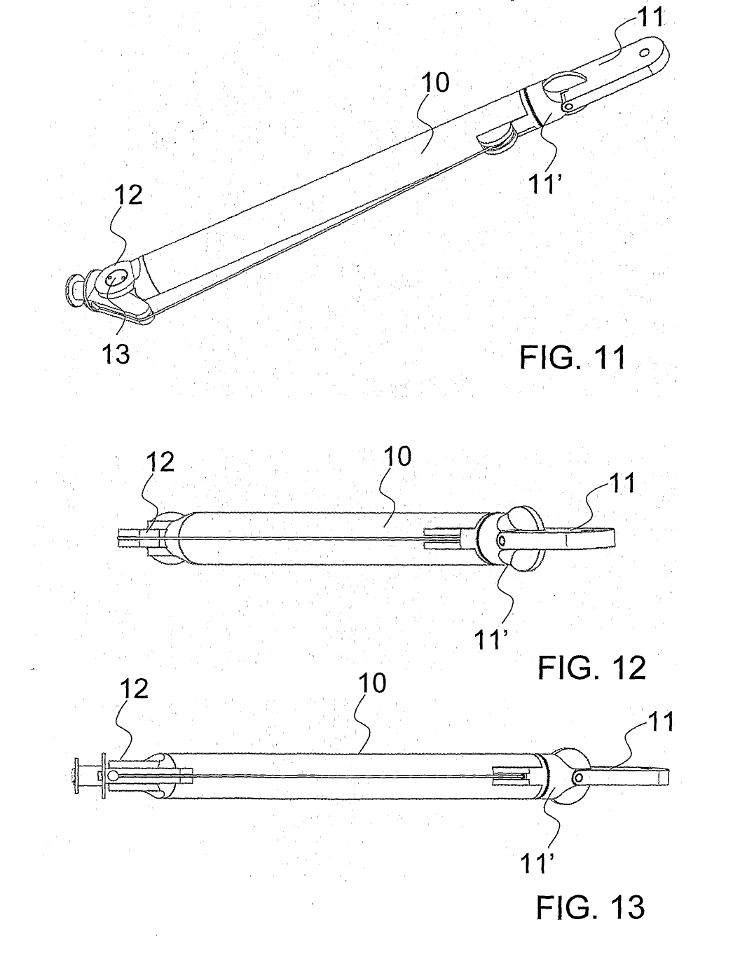

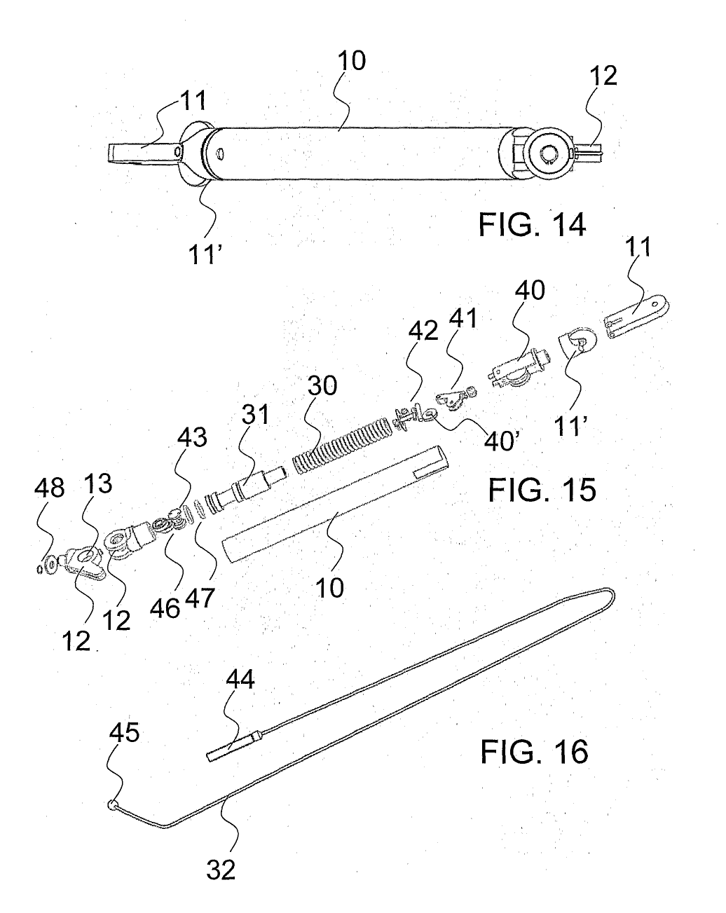

In a preferred embodiment of the invention, see FIGS. 9-14, the construction acting on the spring (30) includes a wire (32) which is secured to the lower part of the brace in the hinge construction (12) at one end and displaceably fastened to a piston (31) that may act on the spring at the other end. In the same way, there is an increasing force in the wire (32) the longer the apparatus (1) goes down, as the spring (30) is tightened hereby. This increasing force arises by extending the lever arm extending from the lowermost pivotal joint (12) and to the joint about which the point of gravity of the apparatus pivots.

When the apparatus (1) is in the uppermost position, the lever arm is short, and at the completely lowered position the lever arm becomes the longest.

This effect is utilised in the sketched invention for weight compensation, where the forces offset each other by increasing lever arm and the spring force . The geometric design of the pivotal points of the braces and the course of the wire in the design is crucial for the weightless sensation.

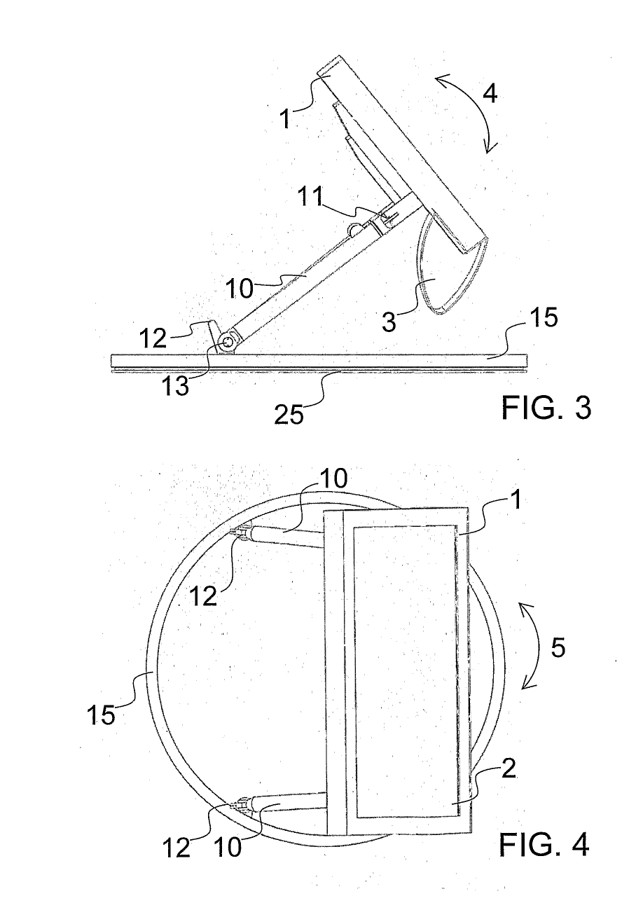

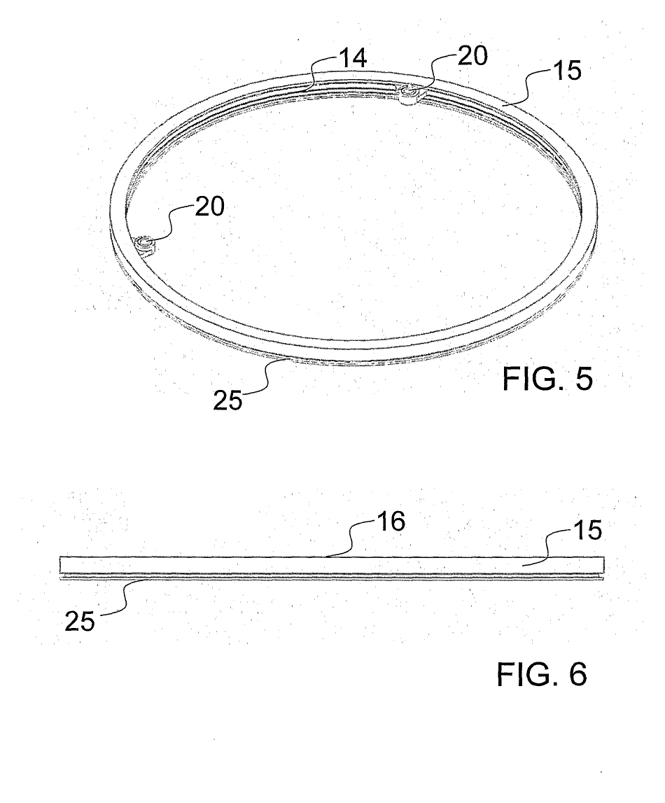

An implementation of the invention is a support for mounting an electronic unit (1) containing a screen (2) as illustrated in FIGS. 1-4, and wherein
the unit (1) is mounted via a top hinge (11) at each of one or more braces (10);
each brace (10) is mounted via a bottom hinge (12) in a movable part (20, see FIG. 5) of an underframe (15);
each brace (10) may be brought from a lower position to an arbitrary upper position by turning the bottom hinge (12) in a vertical plane by an angle which is in the range from horizontal to vertical;
each brace (10) may be brought from an upper position to an arbitrary lower position by turning the bottom hinge (12) in a vertical plane by an angle which is in the range from vertical to horizontal;
the movable part (20) of the underframe (15) may perform a rotating movement about an axis which is vertical in relation to the horizontal plane of a fixed base frame (24, 25).

The mounting-friendliness of the apparatus in question for the user in the support is enhanced in that the top hinge (11) of the brace has two members (11, 11′) that are mutually hinged so that they can be moved in relation to each other in one plane.

Besides, the top hinge (11) of the brace is mounted so that it may rotate freely about the longitudinal axis of the brace.

In one implementation of the invention, bearings are used in all moving joints in order to provide as frictionless operation as possible; this is for enhancing the comfort of the user when the apparatus is to be rotated and/or tilted. A built-in reaction device (30) enables a large degree of freedom with regard to disposition of the apparatus in the vertical plane.

The unit mounted in the brace(s) (10) may thus be brought into a stable state of equilibrium at any position from a lower position of the brace(s) to an upper position of the brace(s), and so that equilibrium is achieved by the self-weight of the unit and by the reaction to the load by an active element (e.g. a spring (30)) in each (of the) brace(s) (10).

In an implementation of the invention, see FIG. 9, the integrated reaction device (active element) is an embedded spring (30), so that the tension of the spring is determined by the pressure from a piston (31), the position of which being determined by the tilting angle of the brace in relation to the centre of rotation (13) of the brace.

The piston (31) acting on the embedded spring (30) is fastened to one end of a wire (32) and the other end of the wire (32) is fastened to the bottom hinge (12) of the brace.

In another implementation of the invention, the integrated reaction device (active element) is a pneumatic or hydraulic component which is embedded so that the tension of the component is determined by the pressure from a piston, the position of which being determined by the tilting angle of the brace in relation to the centre of rotation of the brace. This embodiment is not illustrated.

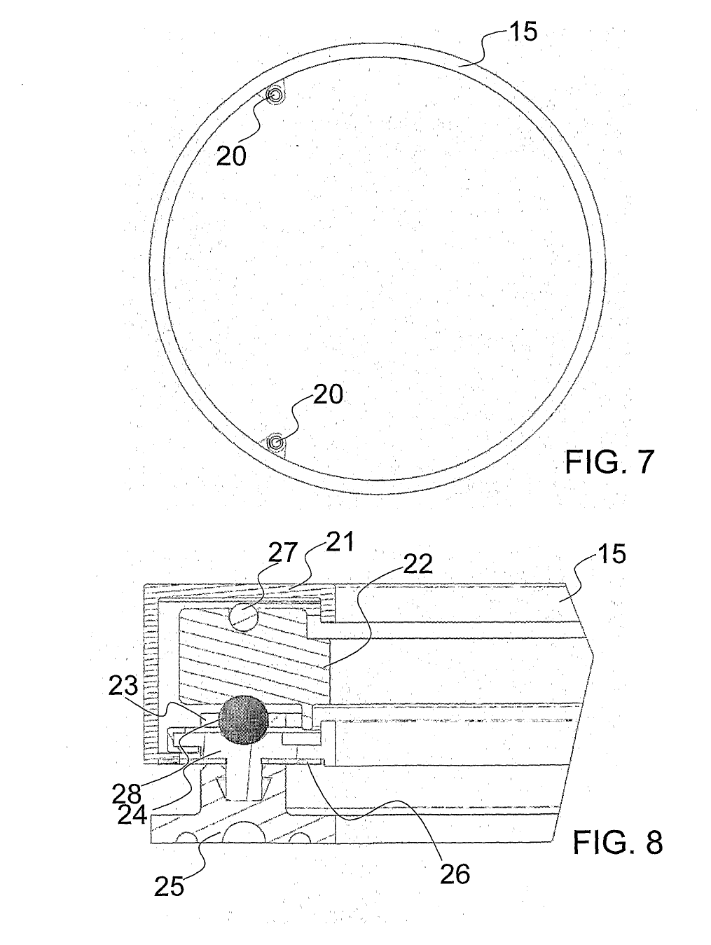

A further aspect of the invention is the circular underframe that enables rotation of the suspended unit, see FIGS. 1-8. The underframe consists of several components: a) a top frame; b) an intermediate layer; c) a base frame; d) a lock frame; and e) protective frame.

In a variation of this aspect, the underframe is generally designed partly circular, i.e. with an opening so that the circle is broken over a greater or lesser section. This will naturally limit the ability of the underframe to rotate the unit about a vertical axis, but in many applications it is sufficient to turn the unit less than +/−90°. In the following, there is generally referred to a circular underframe or components in the underframe, but this is to be regarded as a fully closed circle or a circular shape with an open section as described above.

The function of the individual components are:
a) The top frame (22) constitutes the rotating element (20) upon which the brace (10) is mounted. The top frame can be made of chrome-plated steel, stainless steel, aluminium or similar.
b) The intermediate layer (23) constitutes a guide for ball bearings (28). The intermediate layer can be made of Delrin, ABS, POM or similar.
c) The base frame (24) constitutes the structural part of the underframe. Cavities are provided for accommodating ball bearings (28). The base frame is not visible and can be made of steel, stainless steel or similar.
d) The lock frame (21) constitutes the visible surface (15) of the underframe, at the same time acting as the unifying element of top frame (22), intermediate layer (23) and base frame (24). The lock frame (21) also has the function that by depressing its surface a braking action to the rotating of the unit suspended in the top frame (22) is achieved. This braking action may e.g. be effected by the user slightly treading with a foot on the surface (16) of the underframe. The lock frame (21) can be made of strong plastic (ABS), chrome-plated steel, stainless steel, aluminium or similar.
e) The protective frame (25) constitutes the interface of the underframe to floor or table. This bearing surface has to be gentle to the base (floor), even under the occurring great weight load. The protective frame (25) can be made of strong rubber, PUR or similar.

The user may turn the unit (2), which is mounted on the underframe, to the desired position via a manual process.

In an alternative implementation of the invention, there is fitted a motor unit which by engaging the rotatable top frame may perform a motorised turning of the apparatus mounted upon the underframe.

FIGS. 1-4 show implementation of the invention where the unit (1) is mounted in top hinges (11) at each of two braces (10).

The unit may e.g. be a TV equipped with a screen (2) and a loudspeaker (3).

The braces (10) are via bottom hinges (12) fitted on the movable and circular frame (15) of the support.

The unit may be tilted upwards/downwards, as illustrated by the arrow (4) with centre of rotation at the centre of rotation (13) of the bottom hinge.

The unit can be turned 360°, as illustrated by the arrow (5) by a rotation with centre of rotation in the centre of rotation of the movable circular base frame (15).

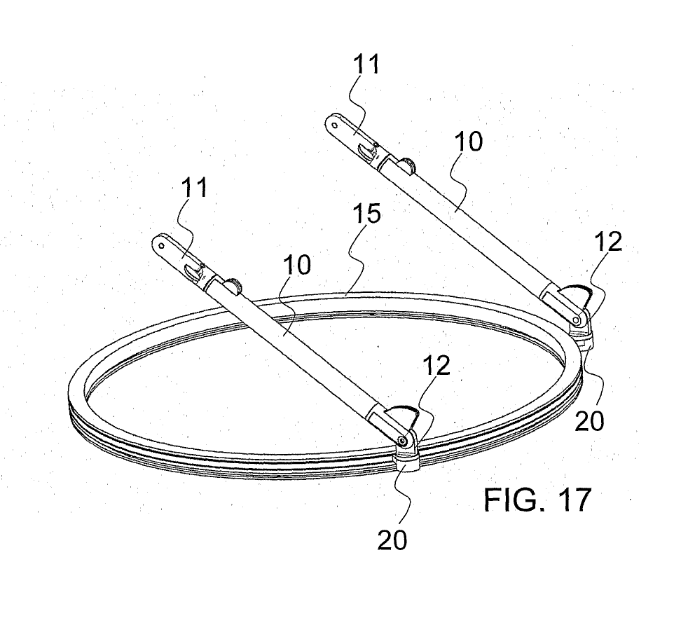

FIGS. 5-8 show an embodiment of the invention, in which it appears that the movable circular base frame (15) has one or more fixing points (20) for mounting the bottom hinges (12) of the support. Referring to FIG. 17 there is shown another embodiment, where the fixing points (20′) are arranged so that the braces are mounted externally on the underframe. The construction illustrated in FIG. 8 is obviously to be designed so that the top frame (22) with mounting or fixing points (20′) constitutes the outer periphery of the underframe.

In a preferred embodiment of the invention, there are two fixing points (20, 20′).

In a further preferred embodiment of the invention, see particularly FIG. 8, the underframe (15) consists of a circular base frame (24) and a circular top frame (22) which is concentrically arranged with respect to the circular base frame, and that base frame and top frame are joined via a frictionless intermediate layer (23) containing a number of ball bearings (28), and that the geometry of the base frame and the geometry of the top frame are designed so that the top frame (22) may rotate freely on the base frame (24) in the horizontal plane of the latter.

In a preferred implementation of the invention, the underframe (15) has a circular lock frame (21) which is concentric with the circular top frame (22), and that the lock frame is mounted on the top frame (22) and the base frame (24) so that the lock frame is acting as a unifying element for the top frame (22), for the intermediate layer (23) and for the base frame (24). A resilient disc (26) is part of the joining mechanism.

In a preferred implementation of the invention, the underframe (15) has a braking function which by friction reduces the rotatability of the movable part (22) of the underframe; this braking function is achieved in that the lock frame (21) in depressed position will block against the possibility of a rotating movement of the top frame (22), and that the lock frame (21) in another, not depressed position, will enable a rotating movement of the top frame (22). The O-ring (27) is the active element in this braking function, as depressing the lock frame (21) will engage the O-ring, whereby the braking action is produced by friction between the lock frame (21) and the O-ring (27) mounted in the top frame (22).

In a preferred implementation of the invention, the underframe (15) has a circular protective frame (25) which is concentric with the circular base frame (24), and the protective frame (25) is mounted on the base frame (24).

FIGS. 9-14 show further details of the invention, in particular details in the brace (10). A bottom hinge (12) is the primary mounting for the base frame (15) of the brace (10).

The swing of the brace (10) in vertical plane is thus about the hinge bearing (13). The bottom hinge (12) is freely rotatable about the fixing points (20, 20′) of the base frame.

The deflection angle of the brace (10) in vertical direction of movement can be limited if this is desirable for a given application of the support. This may e.g. be provided in order to limit the lowermost position to which a unit (1) can be brought. The hinge (12) may thus be provided with a projecting stud (33) which by means of a guideway (50) at the bottom of the brace (10) limits the deflection of the brace.

A spring (30) is used in a preferred embodiment in order to give the required reactive force as counterweight to the weight of the unit (1).

The spring (30) is an integrated part of the brace (10) and is secured between a piston (31) and a fixing unit (34).

The spring (30) is compressed, thereby producing a greater moment in that the brace (10) is pivoted in the hinge (12), whereby the wire (32), which is fastened to the piston (31) and the bottom hinge (12), is tensioned, thereby pulling the piston (31).

The spring (30) is slackened again, thereby producing a lesser moment in that the brace (10) is pivoted in the hinge (12) in the opposite direction, as indicated above, whereby the wire (32), which is fastened to the piston (31) and the bottom hinge (12), is slackened, thereby loosening the piston (31).

In a preferred implementation of the invention, the top hinge of the brace has two members (11, 11′) that are mutually hinged so that they can be moved in relation to each other in one plane.

In a preferred implementation of the invention, the top hinge (11′) of the brace is mounted so that it may rotate freely about the longitudinal axis of the brace (10).

In a preferred implementation of the invention, see FIGS. 9 and 15, 16, wire (32) is suspended via a wheel (40′) having the purpose of reducing the friction when the spring (30) is tensioned/slackened. The wheel (40′) is mounted in an adjusting device (34, 41) which enables fine adjustment of the wire tension via an external access (35) to the adjusting mechanism (34, 41).

FIGS. 15, 16 show an implementation of the invention with further details in the brace (10).

In a preferred implementation of the invention, the use of materials is:

a) The brace (10) can be made of chrome-plated steel, stainless steel or aluminium.

b) The wire (32) diameter is to be >1.8 mm at a unit weight>25 kg.

c) Piston (31) can be made of machined shaft steel.

d) Rings/linings (47) can be made of brass or ceramics.

e) Spring (30) can be made of stainless spring steel, diameter ø27.5 mm, wire diameter ø4.5 mm, length 192.3 mm and tension K=14.3 N/mm.

In a preferred implementation of the invention, wire (32) is connected with the piston (31) via a threaded stub (44) and coupled to the bottom hinge (12) via a ball stub (45) and via a lever arm (49).

In a preferred implementation of the invention, bearings and/or washers are used for reducing wear between the movable parts on which there is a heavy load. The load is caused by the weight of the unit and the reactive force of the spring.

For example, ball bearings (46) and washers (47, 48) are provided at the bottom hinge (12).

In an alternative implementation, the spring (30) with wire arrangement (32) may be substituted by a standard pneumatic arrangement suspended between wheel suspension position (40′) and bottom hinge lever arm (49).

1. A support for mounting an electronic unit containing a screen, wherein the support includes two braces fitted to an underframe containing a base frame, wherein
each brace is provided with a top hinge at an upper end thereof, the hinge including means for mounting a unit;
each brace is provided with a bottom hinge at a lower end thereof, the hinge including means for being mounted in a movable part of the base frame;
each brace may be brought from a lower position to an arbitrary upper position by turning the bottom hinge in a vertical plane by an angle which is in the range from horizontal to vertical;
each brace may be brought from an upper position to an arbitrary lower position by turning the bottom hinge in a vertical plane by an angle which is in the range from vertical to horizontal;
the movable part of the base frame is suspended in a fixed part of the base frame so that the movable part of the base frame may perform a rotating movement around an axis which is vertical in relation to the horizontal plane of the base frame.

2. The support according to claim 1, wherein each of the top hinges of the two braces has two members that are interconnected so that the members can be moved in relation to each other in one plane.

3. The support according to claim 1 wherein each of the top hinges of the two braces is mounted so that it may freely rotate about the longitudinal axis of the brace concerned.

4. The support according to claim 1, wherein the unit mounted in the two braces can be brought into a stable neutral condition in any position from a lower position of the brace(s) to an upper position of the brace(s), and so that equilibrium is attained in the stable neutral condition by the self-weight of the unit and by the response to the load from the self-weight of the unit produced by an active element in each of the two braces.

5. The support according to claim 4, wherein each brace has a spring embedded as an active element, so that the tension of the spring is determined by the pressure from a piston, the position of which being determined by the tilting angle of the brace in relation to the centre of rotation of the brace.

6. The support according to claim 5, wherein the piston acting on the embedded spring is fastened to one end of a wire and that the other end of the wire is fastened to the bottom hinge of the brace.

7. The support according to claim 4, each brace has a pneumatic/hydraulic unit embedded as an active element, so that the tension of the pneumatic/hydraulic unit is determined by the pressure from a piston, the position of which being determined by the tilting angle of the brace in relation to the centre of rotation of the brace.

8. The support according claim 1, wherein the underframe consists of a fixed circular base frame and by a movable circular top frame which is concentrically arranged with respect to the circular base frame, and that between base frame and top frame there is arranged a frictionless intermediate layer containing a number of ball bearings, and that the geometry of the base frame and the geometry of the top frame are designed so that the top frame may rotate freely in relation to the base frame in the plane of the latter.

9. The support according to claim 8, wherein the underframe has a circular lock frame which is concentric with the circular top frame, and that the lock frame is mounted on the top frame and the base frame so that it acts as a unifying element for the top frame, the frictionless intermediate layer and for the base frame.

10. The support according to claim 9, wherein the lock frame is frictionally coupled to the base frame, and that the lock frame in a first position is biased by a spring, in which position the top frame and the base frame may rotate in relation to each other, and that the lock frame can be brought into locking/braking position by counteracting the spring force, whereby friction between the lock frame and the top frame will block a possible rotating movement of the top frame.

11. The support according to claim 10, wherein the underframe has a circular protective frame which is concentric with the circular base frame, and that the base frame is mounted on the protective frame.

12. The support according to claim 1, wherein rotation of the top frame is performed by a motor.
